(19) United States
(12) Patent Application Publication
(10) Pub. No.: US 2024/0355565 A1
(43) Pub. Date: Oct. 24, 2024

(54) ELECTROMAGNETIC RELAY

(71) Applicant: OMRON Corporation, Kyoto-shi (JP)

(72) Inventors: Takeshi NISHIDA, Kyoto-shi (JP); Ayaka MIYAKE, Kyoto-shi (JP); Hiroyasu TANAKA, Kyoto-shi (JP)

(21) Appl. No.: 18/627,453

(22) Filed: Apr. 5, 2024

(30) Foreign Application Priority Data
Apr. 21, 2023 (JP) 2023-069855

(51) Int. Cl. H01H 50/54; H01H 50/02; H01H 50/14

(52) U.S. Cl. CPC H01H 50/54; H01H 50/02; H01H 50/14; H01H 2235/01

(57) ABSTRACT

An electromagnetic relay includes a contact device, a movable member, a driving device, a return spring, and an insulating member. The contact device includes a first fixed terminal, a second fixed terminal, and a movable contact piece. The movable member presses the movable contact piece. The driving device is disposed on one side of a first direction with respect to the contact device and the movable member and moves the movable contact piece via the movable member to one side of a second direction intersecting the first direction. The return spring is disposed between the movable member and the driving device in the first direction for urging the movable member toward another side of the second direction. The insulating member separates the contact device from the driving device and has an opening where the return spring is inserted. The opening is open toward one side of the first direction.

### CROSS-REFERENCE TO RELATED APPLICATION

This application claims priority to Japanese Patent Application No. 2023-069855, filed Apr. 21, 2023. The contents of that application are incorporated by reference herein in their entirety.

### FIELD

The claimed invention relates to an electromagnetic relay.

### BACKGROUND

The electromagnetic relay described in Japanese Patent Application Publication No. 1994-012956 includes a contact device including a movable contact piece, a movable member configured to press the movable contact piece, a driving device configured to move the movable contact piece via the movable member, and a return spring for urging the movable member to a return position.

In a conventional electromagnetic relay, a return spring is placed below the movable member. With this configuration, attachment of the return spring is difficult in assembling the electromagnetic relay. Hence, there is room for improvement.

### SUMMARY

An object of the claimed invention is to provide an electromagnetic relay in which a return spring can be mounted easily.

An electromagnetic relay according to one aspect of the claimed invention includes a contact device, a movable member, a driving device, a return spring, and an insulating member. The contact device includes a first fixed terminal including a first fixed contact, a second fixed terminal including a second fixed contact, and a movable contact piece opposing the first fixed contact and the second fixed contact. The movable member is configured to press the movable contact piece. The driving device is disposed on one side of a first direction with respect to the contact device and the movable member, and configured to move the movable contact piece to one side of a second direction intersecting the first direction via the movable member. The return spring is disposed between the movable member and the driving device in the first direction. The return spring urges the movable member toward another side of the second direction. The insulating member separates the contact device from the driving device. The insulating member has an opening into which the return spring is inserted. The opening is open toward the one side of the first direction.

In this electromagnetic relay, the return spring is disposed between the movable member and the driving device in the first direction, and the insulating member separating the contact device from the driving device has an opening into which the return spring is inserted. With this configuration, for example, after the contact device, the movable member, and the insulating member are assembled, the return spring can be easily mounted by its insertion into the opening of the insulating member. Also, it can be visually confirmed through the opening of the insulating member that the return spring is securely assembled. Furthermore, compared to an electromagnetic relay in which a return spring and a movable member are arranged side by side in the second direction, this electromagnetic relay can be downsized in the second direction. Furthermore, it is possible to secure a space for an auxiliary contact without increasing in size of the electromagnetic relay from in the second direction.

The insulating member may include a guide section configured to guide movement of the movable member in the first direction. In this case, the insulating member is able to guide the movement of the movable member.

Either the movable member or the insulating member may include an insulating wall surrounding at least part of the return spring. In this case, the insulating wall is able to insulate between the contact device and the return spring.

The insulating member may include a guide section to guide movement of the movable member in the first direction. The insulating wall of the movable member may be slidable relative to the guide section. In this case, the insulating wall can also serve as a guide for the movement of the movable member.

The first fixed terminal and the second fixed terminal may be fixed to the insulating member by press-fitting. In this case, since the first fixed terminal and the second fixed terminal are fixed to the insulating member by press-fitting that includes the guide section, the movable member can be arranged with high precision.

The opening of the insulating member may include an edge section configured to cover part of the return spring. In this case, the return spring becomes unlikely to come out of the opening.

The edge section of the opening of the insulating member may include a first edge configured to cover a first end of the return spring and a second edge configured to cover a second end of the return spring. In this case, the return spring becomes more unlikely to come out of the opening.

Either the movable member or the insulating member may include a positioning section configured to position a first end of the return spring. In this case, the return spring can be easily positioned.

The opening of the insulating member may include an edge section configured to cover a second end of the return spring. In this case, the return spring becomes less likely to come out of the opening.

The electromagnetic relay may further include an auxiliary contact device aligned with the contact device in the second direction. In this case, the arrangement of an electromagnetic relay even including a return spring and an auxiliary contact does not increase the size of the electromagnetic relay in the second direction.

### BRIEF DESCRIPTION OF THE DRAWINGS

FIG. 1 is a perspective view of an electromagnetic relay in accordance with the claimed invention.

FIG. 2 is a side view of an electromagnetic relay in accordance with the claimed invention.

FIG. 3 is a perspective view of the electromagnetic relay in FIG. 1 with a driving device and an insulating member removed.

FIG. 4 is a perspective view of the electromagnetic relay in FIG. 1 with a driving device removed.

FIG. 5 is a diagram of an insulating member viewed diagonally from below.

FIG. 6 is a partial cross-sectional view of a return spring and therearound.

FIG. 7 is a diagram for illustrating a modification of an opening.

### DETAILED DESCRIPTION

An embodiment of an electromagnetic relay 1 according to one aspect of the claimed invention will be described below with reference to the drawings. When referring to the drawings, the direction indicated by arrows X1 and X2 (an example of the second direction) will be explained as a front-rear direction. The direction indicated by arrows Y1, Y2 will be explained as a left-right direction, and the direction indicated by arrows Z1, Z2 (an example of the first direction) will be explained as an up-down direction. Also, in the description below, the direction indicated by the arrow X1 is forward, the direction indicated by arrow X2 is rearward, the direction indicated by arrow Y1 is leftward, the direction indicated by arrow Y2 is rightward, the direction indicated by arrow Z1 is upward, and the direction indicated by arrow Z2 is downward. These directions are defined for convenience of description, and do not limit the arrangement directions of electromagnetic relay 1.

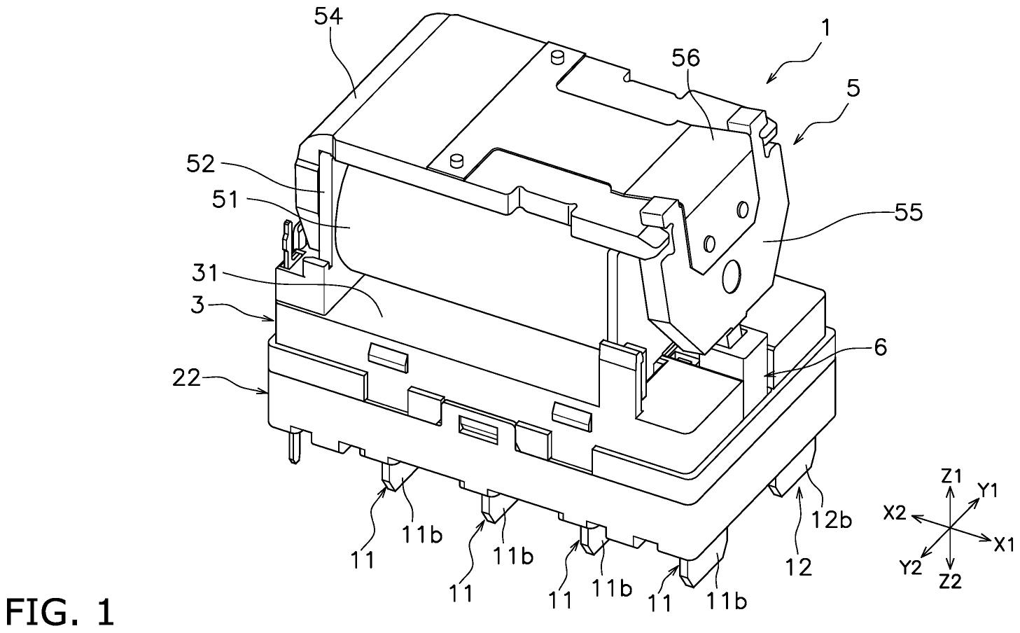

As shown in FIGS. 1 to 3, the electromagnetic relay 1 includes a case 2, an insulating member 3, a contact device 4, a driving device 5, a movable member 6, and a return spring 7.

The case 2 is comprised of insulating material such as resin. The case 2 includes a first cover 21 and a second cover 22. The first cover 21 has a substantially rectangular box shape and is open downward. The first cover 21 is disposed above the insulating member 3. The first cover 21 is coupled to the insulating member 3 by, for example, a snap fit. Note that the first cover 21 is not shown in FIG. 1.

The second cover 22 has a substantially rectangular box shape and is open upward. The second cover 22 is disposed below the insulating member 3. The second cover 22 is coupled to the insulating member 3 by, for example, a snap fit.

The insulating member 3 is comprised of insulating material such as resin. The insulating member 3 separates the contact device 4 from the driving device 5. The insulating member 3 is arranged between the contact device 4 and the driving device 5. The insulating member 3 insulates the contact device 4 from the driving device 5. The insulating member 3 defines, in the case 2, a space where the contact device 4 is disposed and a space where the driving device 5 is disposed. The insulating member 3 will be described in more detail below.

The contact device 4 is arranged in the internal space defined by the second cover 22 and the insulating member 3. The contact device 4 includes multiple contact sets 10. In the present embodiment, the contact device 4 includes four contact sets 10: first to fourth contact sets 10a to 10d. The first to fourth contact sets 10a to 10d are aligned in the front-rear direction.

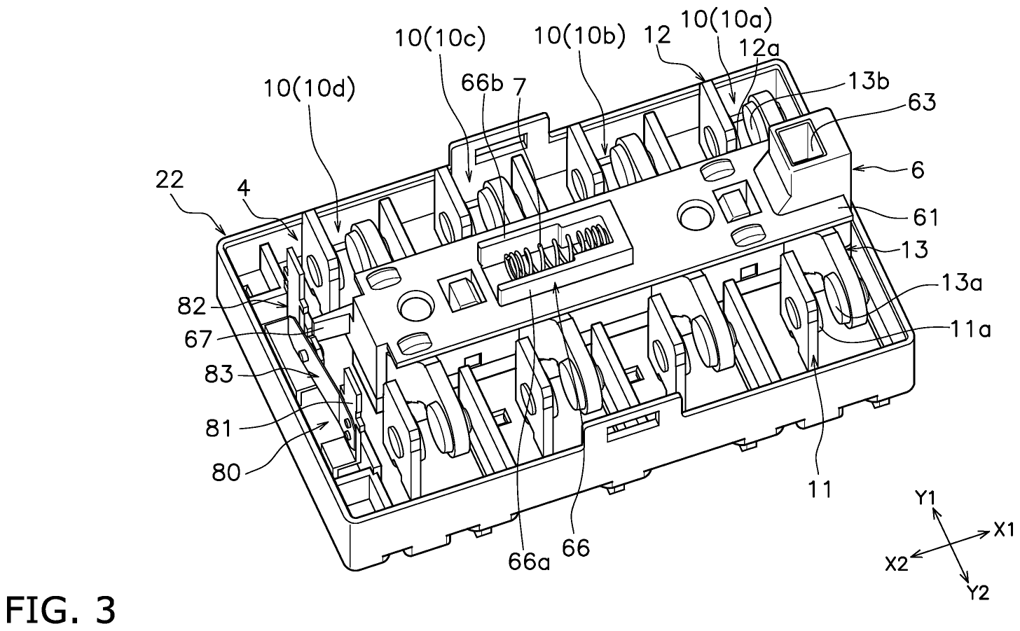

The first to fourth contact sets 10a to 10d have similar configurations. Each of the first to fourth contact sets 10a to 10d includes a first fixed terminal 11, a second fixed terminal 12, a movable contact piece 13, and a contact spring 14. Here, only the details of the first fixed terminal 11, the second fixed terminal 12, the movable contact piece 13, and the contact spring 14 of the first contact set 10a will be explained. In FIG. 3, the same reference numerals as those in the first contact set 10a in the second to fourth contact sets 10b to 10d are omitted.

The first fixed terminal 11 is a plate terminal and is comprised of conductive material. The first fixed terminal 11 is supported by the insulating member 3. The first fixed terminal 11 is fixed to the insulating member 3 by press-fitting, for example.

The first fixed terminal 11 includes a first fixed contact 11a and a first external connection 11b. The first fixed contact 11a is arranged on the front surface of the first fixed terminal 11. The first external connection 11b projects downward from the second cover 22.

The second fixed terminal 12 is a plate terminal and is comprised of conductive material. The second fixed terminal 12 is supported by the insulating member 3. The second fixed terminal 12 is fixed to the insulating member 3, for example, by press-fitting. The second fixed terminal 12 is arranged apart from the first fixed terminal 11 in the left-right direction.

The second fixed terminal 12 includes a second fixed contact 12a and a second external connection 12b. The second fixed contact 12a is arranged on the front surface of the second fixed terminal 12. The second external connection 12b projects downward from the second cover 22.

The movable contact piece 13 is a plate terminal and is comprised of conductive material. The movable contact piece 13 extends in the left-right direction. The movable contact piece 13 is arranged in front of the first fixed contact 11a and the second fixed contact 12a, and is opposed to the first fixed contact 11a and the second fixed contact 12a in the front-rear direction. The movable contact piece 13 is connected to the movable member 6 via the contact spring 14 in the front-rear direction. The movable contact piece 13 is arranged to be movable relative to the movable member 6 in the front-rear direction.

The movable contact piece 13 is configured to be movable in the front-rear direction. The movable contact piece 13 is configured to be movable in a contact direction from the first movable contact 13a toward the first fixed contact 11a and in a separation direction opposite to the contact direction. In the present embodiment, the contact direction corresponds to the rearward direction, and the separation direction corresponds to the forward direction.

The movable contact piece 13 includes a first movable contact 13a, a second movable contact 13b, and a positioning section 13c. The first movable contact 13a faces the first fixed contact 11a in the front-rear direction. The first movable contact 13a contacts the first fixed contact 11a or separates from the first fixed contact 11a in accordance with the movement of the movable member 6. The second movable contact 13b faces the second fixed contact 12a in the front-rear direction. The second movable contact 13b contacts the second fixed contact 12a or separates from the second fixed contact 12a in accordance with the movement of the movable member 6. The positioning section 13c is located at the center of the movable contact piece 13 in the left-right direction. The positioning section 13c has a protrusion shape projecting forward from the front surface of the movable contact piece 13.

The contact spring 14 urges the movable contact piece 13 in the contact direction. The contact spring 14 is positioned by the positioning section 13c.

The driving device 5 is arranged in the internal space defined by the insulating member 3 and the first cover 21. The driving device 5 is disposed above the contact device 4 and the movable member 6. The driving device 5 is placed on top of the insulating member 3. The driving device 5 is configured to move the movable contact piece 13 of each of the first to fourth contact sets 10a to 10d in the front-rear direction via the movable member 6. In the present embodiment, the driving device 5 generates electromagnetic force for moving the movable member 6 in the contact direction.

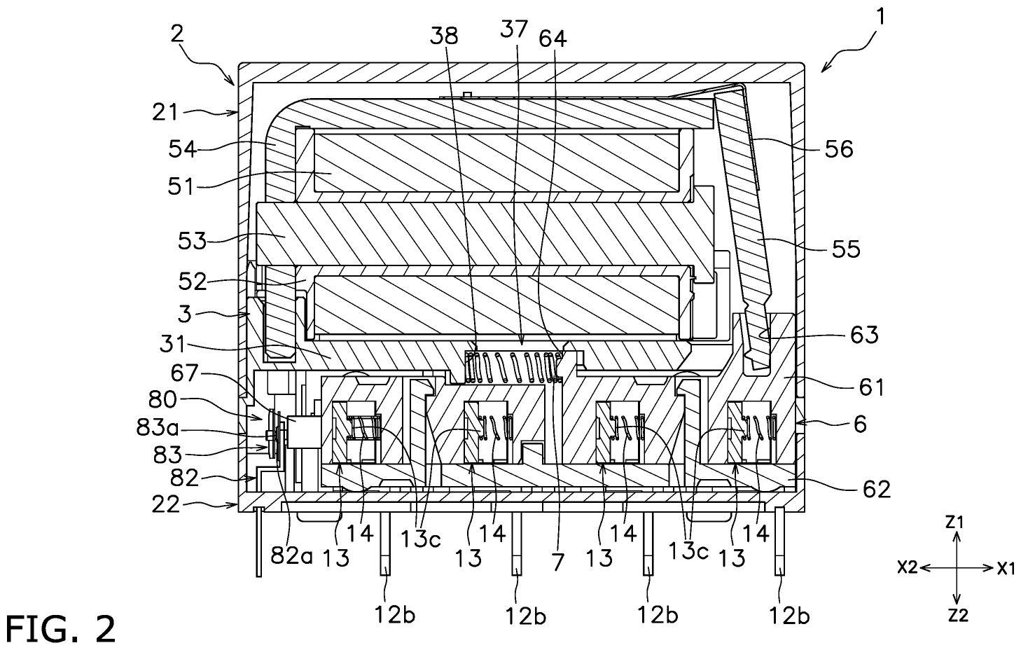

As shown in FIGS. 1 and 2, the driving device 5 includes a coil 51, a bobbin 52, a fixed iron core 53, a yoke 54, a movable iron piece 55, and a hinge spring 56. The coil 51 is wound around the bobbin 52. The axis of the bobbin 52 extends in the front-rear direction. The fixed iron core 53 is arranged within the bobbin 52. Both ends of the fixed iron core 53 in the front-rear direction protrudes from the bobbin 52. The yoke 54 The yoke 54 has a bent shape, an L-shape. The yoke 54 is arranged above the coil 51 and behind the bobbin 52. The yoke 54 is connected to the rear end of the fixed iron core 53.

The movable iron piece 55 is connected to the front end of the yoke 54. The movable iron piece 55 is rotatably supported by the yoke 54 via the hinge spring 56. The movable iron piece 55 rotates about the front end of the yoke 54 as a fulcrum. The movable iron piece 55 is arranged in front of the fixed iron core 53. The lower end of the movable iron piece 55 is connected to the movable member 6. The hinge spring 56 urges the movable iron piece 55 in a direction away from the fixed iron core 53.

The movable member 6 is comprised of insulating material such as resin. The movable member 6 extends in the front-rear direction. The movable member 6 is arranged in the internal space defined by the second cover 22 and the insulating member 3. The movable member 6 is disposed below the insulating member 3. The movable member 6 is placed on top of the second cover 22. The movable member 6 is arranged between the first fixed terminal 11 and the second fixed terminal 12. The movable member 6 is configured to press the movable contact piece 13. The movable member 6 is pressed by the movable iron piece 55 as the movable iron piece 55 rotates. With the configuration, the movable member 6 is movable in the front-rear direction.

As shown in FIGS. 2, 3, and 6, the movable member 6 includes a main body section 61, a cover section 62, an insertion hole 63, a first contact section 64, a positioning section 65, and an insulating wall 66. The main body section 61 includes four spaces in which the movable contact pieces 13 and contact springs 14 of each of the first to fourth contact sets 10a to 10d are accommodated. The four spaces are aligned side by side in the front and rear direction. As shown in FIG. 2, the cover section 62 closes off the lower portions of the four spaces. The cover section 62 is coupled to the main body section 61, by a snap fit, for example. The insertion hole 63 is located at the upper portion of the front end of the main body section 61. The insertion hole 63 extends in the up-down direction. The insertion hole 63 is open upward, into which the lower end of the movable iron piece 55 is inserted. The insertion hole 63 is arranged within an opening formed in the insulating member 3.

The first contact section 64 is formed on top of the main body section 61. The first contact section 64 is arranged approximately at the center of the main body section 61 in the front-rear direction. The first contact section 64 projects upward from the upper surface of the main body section 61. The first contact section 64 extends in a direction intersecting the front-rear direction. The first contact section 64 is where a first end of the return spring 7 contacts. In the present embodiment, the first contact section 64 is contacted by the front end of the return spring 7.

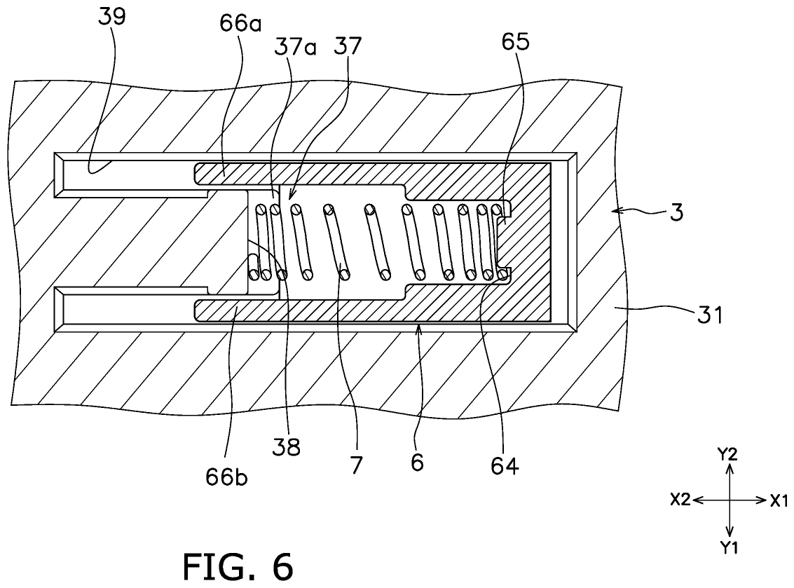

As shown in FIG. 6, the positioning section 65 positions the first end of the return spring 7. The positioning section 65 is arranged on the first contact section 64. The positioning section 65 is shaped to protrude rearward from the rear surface of the first contact section 64. The positioning section 65 has an outer diameter smaller than the inner diameter of the return spring 7. The positioning section 65 is disposed inside the return spring 7. Note that the positioning section 65 may be shaped to accommodate the first end of the return spring 7. For example, the positioning section 65 may have a shape recessed toward the front.

The insulating wall 66 projects upward from the top surface of the main body section 61. The insulating wall 66 extends in a direction intersecting the left-right direction. The insulating wall 66 extends in the front-rear direction and the up-down direction. The insulating wall 66 surrounds at least part of the return spring 7. The insulating wall 66 is arranged to surround the left and right sides of the return spring 7. The insulating wall 66 insulates between the return spring 7 and the contact device 4. The insulating wall 66 is connected to the first contact section 64. The insulating wall 66 includes a first wall section 66a and a second wall section 66b facing the first wall section 66a in the left-right direction.

Here, as shown in FIGS. 2 to 6, the insulating member 3 includes a partition wall 31, multiple positioning recesses 32, a first terminal fixing section 33, a second terminal fixing section 34, a first insulating wall 35, a second insulating wall 36, an opening 37, a second contact section 38, and a guide section 39.

The partition wall 31 separates the contact device 4 from the driving device 5. The partition wall 31 defines, within the case 2, a space where the contact device 4 is disposed and a space where the driving device 5 is disposed. The partition wall 31 extends in a direction intersecting the up-down direction.

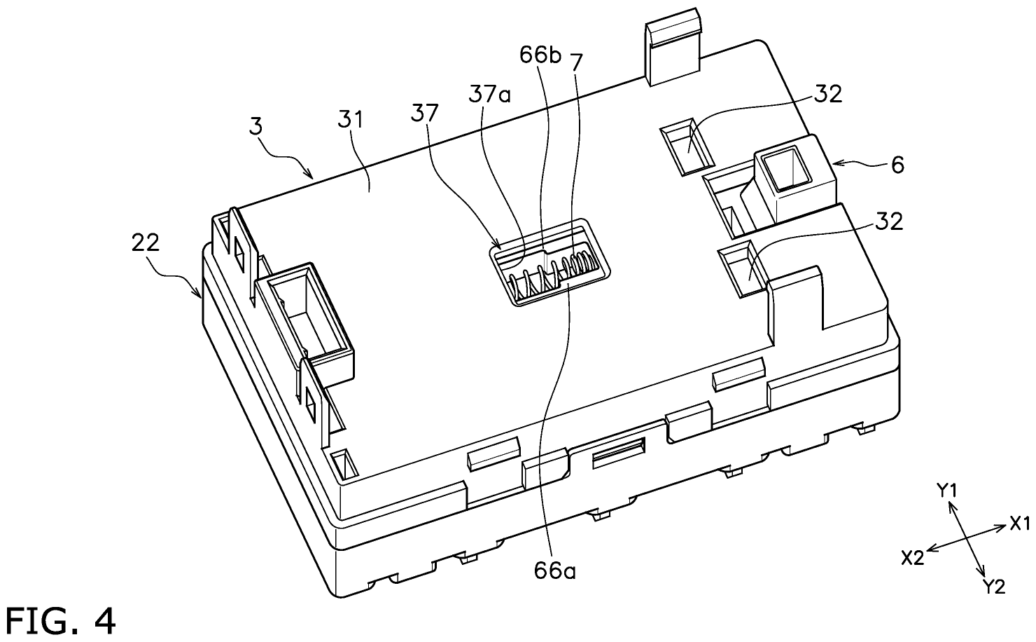

As shown in FIG. 4, the multiple positioning recesses 32 are arranged in the upper surface of the partition wall 31. The multiple positioning recesses 32 are recessed downward. The multiple positioning recesses 32 position the bobbin 52.

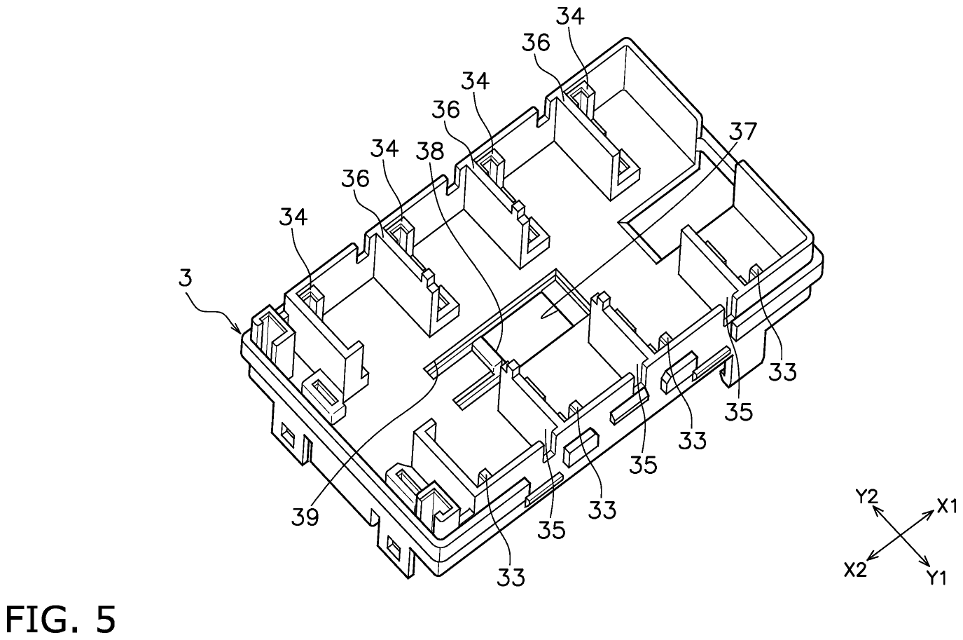

As shown in FIG. 5, the first terminal fixing section 33 and the second terminal fixing section 34 extend downward from the lower surface of the partition wall 31. The first terminal fixing section 33 and the second terminal fixing section 34 are shaped to be recessed upward. The first terminal fixing section 33 is separated from the second terminal fixing section 34 in the left-right direction. The first fixed terminal 11 is fixed by press-fitting to the first terminal fixing section 33. The second fixed terminal 12 is fixed by press-fitting to the second terminal fixing section 34. The first terminal fixing section 33 and the second terminal fixing section 34 are provided according to the number of the multiple contact sets 10.

The first insulating wall 35 and the second insulating wall 36 insulate between the multiple contact sets 10. The first insulating wall 35 and the second insulating wall 36 extend downward from the lower surface of the partition wall 31. The first insulating wall 35 and the second insulating wall 36 extend in a direction intersecting the front-rear direction. The first insulating wall 35 is separated from the second insulating wall 36 in the left-right direction. The movable member 6 is arranged between the first insulating wall 35 and the second insulating wall 36.

The opening 37 is open upward. The opening 37 is where the return spring 7 is inserted. The opening 37 passes through the partition wall 31 in the up-down direction. The opening 37 has a substantially rectangular shape when viewed in the up-down direction. The opening 37 extends in the front-rear direction. The opening 37 has a dimension in the front-rear direction that is shorter than the free length of the return spring 7.

As shown in FIG. 6, the opening 37 includes an edge section 37a for covering part of the return spring 7. The edge section 37a overlaps the part of the return spring 7 when viewed in the up-down direction. The edge section 37a covers a second end (here, the rear end) of the return spring 7.

The second contact section 38 projects downward from the lower surface of the partition wall 31. The second contact section 38 extends in a direction intersecting the front-rear direction. The second contact section 38 is arranged behind the first contact section 64 and faces the first contact section 64 in the front-rear direction. The second contact section 38 is where the second end of the return spring 7 contacts. In the present embodiment, the second contact section 38 is contacted by the rear end of the return spring 7. The second contact section 38 is disposed between the first wall section 66a and the second wall section 66b of the insulating wall 66. In the present embodiment, the first contact section 64 is contacted by the front end of the return spring 7.

The guide section 39 guides movement of the movable member 6 in the front-rear direction. The guide section 39 guides movement of the insulating wall 66 of the movable member 6 in the front-rear direction. The guide section 39 is formed on the lower surface of the partition wall 31. The guide section 39 extends in the front-rear direction. The guide section 39 has a shape recessed rearward. The guide section 39 extends rearward from both ends of the second contact section 38 in the left and right direction. The guide section 39 has a groove shape. The first wall section 66a and the second wall section 66b of the insulating wall 66 are arranged within the groove of the guide section 39. The first wall section 66a and the second wall section 66b of the insulating wall 66 are slidable relative to the guide section 39.

The return spring 7 urges the movable member 6 in the separation direction. The return spring 7 is, for example, a coil spring, and is arranged between the driving device 5 and the movable member 6 in the up-down direction. The return spring 7 is arranged between the first wall section 66a and the second wall section 66b. The return spring 7 is arranged between the first contact section 64 and the second contact section 38. The return spring 7 is arranged between the first contact section 64 and the second contact section 38 when the return spring 7 in a compressed state is inserted into the opening 37 of the insulating member 3 from above the opening 37 after the contact device 4 and movable member 6 are attached to the insulating member 3 and the second cover 22.

As shown in FIGS. 2 and 3, the electromagnetic relay 1 further includes an auxiliary contact device 80. The auxiliary contact device 80 is aligned with the contact device 4 in the front-rear direction. The auxiliary contact device 80 is arranged behind the contact device 4. The auxiliary contact device 80 includes a first auxiliary fixed terminal 81, a second auxiliary fixed terminal 82, and an auxiliary movable contact piece 83.

The first auxiliary fixed terminal 81 and the second auxiliary fixed terminal 82 are supported by the insulating member 3. The first auxiliary fixed terminal 81 is separated from the second auxiliary fixed terminal 82 in the left-right direction. The second auxiliary fixed terminal 82 includes an auxiliary fixed contact 82a. The auxiliary fixed contact 82a is arranged on the front surface of the first auxiliary fixed terminal 81.

The auxiliary movable contact piece 83 is composed of a leaf spring. The auxiliary movable contact piece 83 extends in the left-right direction. The auxiliary movable contact piece 83 has one end fixed to the first auxiliary fixed terminal 81. The other end of the auxiliary movable contact piece 83 is a free end and is arranged behind the auxiliary fixed contact 82a. The other end of the auxiliary movable contact piece 83 faces the auxiliary fixed contact 82a in the front-rear direction.

The auxiliary movable contact piece 83 includes an auxiliary movable contact 83a. The auxiliary movable contact 83a is arranged at the free end of the auxiliary movable contact piece 83. The free end of the auxiliary movable contact piece 83 is pressed against a pressing protrusion 67 of the movable member 6 as the movable member 6 moves. As a result, the auxiliary movable contact 83a contacts the auxiliary fixed contact 82a or separates from the auxiliary fixed contact 82a.

In the present embodiment, the auxiliary movable contact 83a contacts the auxiliary fixed contact 82a in a state where the free end of the auxiliary movable contact piece 83 is not pressed by the pressing protrusion 67. In contrast, the auxiliary movable contact 83a separates from the auxiliary fixed contact 82a in a state where the free end of the auxiliary movable contact piece 83 is pressed by the pressing protrusion 67.

Next, the operations of contact device 4, driving device 5, and movable member 6 will be explained. When no voltage is applied to the coil 51, the movable member 6 is pressed in the separation direction by the elastic force of the hinge spring 56 and the return spring 7, and the movable member 6 is located at the return position shown in FIG. 3. At this time, in each of the first contact set 10a to the fourth contact set 10d, the first movable contact 13a is separated from the first fixed contact 11a, and the second movable contact 13b is separated from the second fixed contact 12a.

When a voltage is applied to the coil 51 and the driving device 5 is excited, the movable iron piece 55 is attracted to the fixed iron core 53 and rotates, and the movable member 6 is pressed in the contact direction. As a result, the movable member 6 moves in the contact direction against the elastic force of the return spring 7. As the movable member 6 moves in the contact direction, the movable contact piece 13 in each of the first to fourth contact sets 10a to 10d moves in the contact direction. Accordingly, in each of the first to fourth contact sets 10a to 10d, the first movable contact 13a contacts the first fixed contact 11a, and the second movable contact 13b contacts the second fixed contact 12a. When the voltage application to the coil 51 is stopped, the movable member 6 moves in the separation direction by the elastic force of the hinge spring 56 and the return spring 7 and returns to the return position.

In this electromagnetic relay 1, the return spring 7 is arranged between the movable member 6 and the driving device 5 in the front-rear direction, and the insulating member 3 separating the contact device 4 and the driving device 5 has an opening 37 into which the return spring 7 is inserted. With the configuration, the return spring 7 can be easily mounted by its insertion through opening 37 of insulating member 3 after the contact device 4, the movable member 6, and the insulating member 3 are assembled, for example. Further, it can be visually confirmed through the opening 37 of the insulating member 3 that the return spring 7 is reliably assembled. Furthermore, compared to an electromagnetic relay in which the return spring 7 and the movable member 6 are arranged side by side in the front-rear direction, the electromagnetic relay 1 can be downsized in the front-rear direction. In addition, it is possible to secure a space where the auxiliary contact device 80 is disposed without increasing the size of the electromagnetic relay 1 in the front-rear direction.

One embodiment of the electromagnetic relay according to one aspect of the claimed invention has been described above. The claimed invention, however, is not limited to the above embodiment, and various changes can be made without departing from the scope of the claimed invention.

The configuration of contact device 4 may be changed. The contact device 4 only needs to include at least one contact set. For example, the second to fourth contact sets 10b to 10d may be omitted. The auxiliary contact device 80 may be omitted. The contact device 4 may include a contact set of B-contact type. The first fixed terminal 11 and the second fixed terminal 12 may be fixed by press-fitting to the second cover 22. The claimed invention may be applied to an electromagnetic relay in which the movable contact piece 13 is arranged behind the first fixed terminal 11 and the second fixed terminal 12.

The configuration of driving device 5 may be changed. The yoke 54 may be arranged, for example, below the coil 51 and to the left of the bobbin 52. The yoke 54 may be used to prevent the return spring 7 from coming out of the opening 37.

The guide section 39 may be configured, for example, to guide the left and right side walls of the main body section 61 of the movable member 6. In other words, the left and right side walls of the main body section 61 of the movable member 6 may be slidable relative to the guide section 39, thereby guiding the movement of the movable member 6 in the front-rear direction.

In the above embodiment, the insulating wall 66 is formed on the movable member 6, but the insulating wall 66 may be formed on the insulating member 3.

In the above embodiment, the positioning section 65 is formed on the movable member 6, but the positioning section 65 may be formed on the insulating member 3.

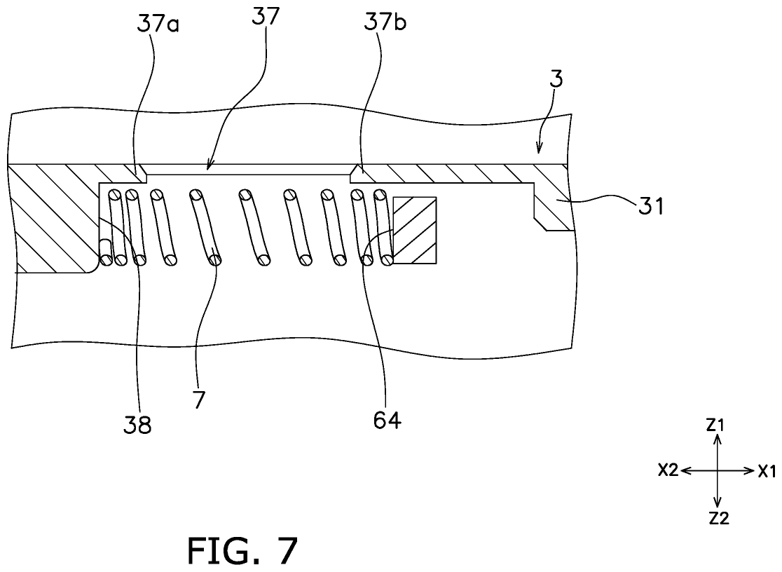

The shape of opening 37 may be changed. As schematically shown in FIG. 7, the opening 37 may include an edge section 37b for covering the first end (here, the front end) of the return spring 7. The edge section 37b covers the first end of the return spring 7 in a state where the first movable contact 13a is in contact with the first fixed contact 11a. That is, FIG. 7 shows a state in which the return spring 7 is compressed in a state where the return spring 7 is compressed in the contact direction by the movable member 6 and the first movable contact 13a is in contact with the first fixed contact 11a.

### REFERENCE NUMERALS

1 Electromagnetic relay
3 Insulating member
4 Contact device
5 Driving device
6 Movable member
7 Return spring
37 Opening
39 Guide section
65 Positioning section
66 Insulating wall
80 Auxiliary contact device

1. An electromagnetic relay, comprising:
a contact device including a first fixed terminal that has a first fixed contact, a second fixed terminal that has a second fixed contact, and a movable contact piece opposing the first fixed contact and the second fixed contact;
a movable member configured to press the movable contact piece;
a driving device disposed on one side of a first direction with respect to the contact device and the movable member, the driving device being configured to move the movable contact piece via the movable member to one side of a second direction intersecting the first direction;
a return spring disposed between the movable member and the driving device in the first direction, the return spring being configured to urge the movable member toward another side of the second direction; and
an insulating member having an opening into which the return spring is inserted, the opening being open toward the one side of the first direction, the insulating member separating the contact device from the driving device.

2. The electromagnetic relay according to claim 1, wherein
the insulating member includes a guide section configured to guide movement of the movable member in the first direction.

3. The electromagnetic relay according to claim 1, wherein
either the movable member or the insulating member includes an insulating wall surrounding at least part of the return spring.

4. The electromagnetic relay according to claim 3, wherein
the insulating member includes a guide section configured to guide movement of the movable member in the first direction, and
the insulating wall is slidable relative to the guide section.

5. The electromagnetic relay according to claim 2, wherein
the first fixed terminal and the second fixed terminal are fixed to the insulating member by press-fitting.

6. The electromagnetic relay according to claim 1, wherein
the opening of the insulating member includes an edge section configured to cover part of the return spring.

7. The electromagnetic relay according to claim 6, wherein
the edge section of the opening of the insulating member includes a first edge configured to cover a first end of the return spring and a second edge configured to cover a second end of the return spring.

8. The electromagnetic relay according to claim 1, wherein
either the movable member or the insulating member includes a positioning section configured to position a first end of the return spring.

9. The electromagnetic relay according to claim 8, wherein
the opening of the insulating member includes an edge section configured to cover a second end of the return spring.

10. The electromagnetic relay according to claim 1, further comprising
an auxiliary contact device aligned with the contact device in the second direction.
